(19) United States
(12) Patent Application Publication
(10) Pub. No.: US 2024/0264287 A1
(43) Pub. Date: Aug. 8, 2024

(54) PULSED LIDAR SYSTEM

(71) Applicant: OFFICE NATIONAL D'ETUDES ET DE RECHERCHES AÉROSPATIALES, PALAISEAU (FR)

(72) Inventors: Laurent LOMBARD, PALAISEAU (FR); Agnès DOLFI-BOUTEYRE, PALAISEAU (FR)

(21) Appl. No.: 18/558,967

(22) PCT Filed: Apr. 26, 2022
(86) PCT No.: PCT/FR2022/050781

§ 371 Date: Nov. 3, 2023

(30) Foreign Application Priority Data
May 6, 2021 (FR) 2104768

(51) Int. Cl. G01S 7/487; G01S 7/4861; G01S 17/58; G01S 17/95

(52) U.S. Cl. CPC G01S 7/487; G01S 7/4861; G01S 17/58; G01S 17/95

(57) ABSTRACT

A pulsed LIDAR system has a transmission path that is configured to form each pulse as a superposition of a plurality of pulse spectral components that are emitted simultaneously. A signal-to-noise ratio of a heterodyne detection signal is improved in this manner. A LIDAR system of this kind can be implemented using optical fibers, and is particularly suitable for performing airspeed measurements.

### TECHNICAL FIELD

This description relates to a pulsed LIDAR system, in particular such a LIDAR system which is adapted to perform airspeed measurements. Although LIDAR is the acronym for Light Detection And Ranging, LIDAR systems are highly suitable for carrying out speed measurements at a distance.

### PRIOR ART

Determining the wind speed at a distance is useful in many fields, particularly aviation safety, for example in order to detect the presence of turbulence near airport runways, or to detect gusts of wind when on board an aircraft in flight in order to compensate for the effects of premature wear caused by gusts on the aircraft's structures. Other areas where such knowledge is also useful are the surveying and management of wind farm sites, or the measurement of atmospheric currents from space for weather forecasts.

In a known manner, a pulsed LIDAR system makes it possible to measure the speed component of a target which is parallel to the direction of emission of the LIDAR system, as well as the distance separating the target from the LIDAR system. In particular, a pulsed LIDAR system which is configured for airspeed measurements makes it possible to obtain estimates of the wind speed component that is parallel to the direction of emission of the LIDAR system, as a function of the separation distance measured along this direction of emission. However, for such airspeed measurements, the signals which are detected by the LIDAR system and from which the measurement results for the wind speed are obtained, are produced by a backscattering of the emitted pulses which is caused by particles suspended in the air. These detection signals have very low intensities, so it is important to improve the signal-to-noise ratio associated with them.

Also in a known manner, when the pulsed LIDAR system uses heterodyne detection, meaning when the system is coherent between emission and detection, its signal-to-noise ratio is proportional to E·PRF^{1/2}, where E is the energy of each pulse that is backscattered and then detected, and PRF is the pulse repetition frequency. Efforts are therefore made to increase the values for the energy E and frequency PRF.

Increasing the energy E could be achieved by increasing the energy of each pulse as emitted by the LIDAR system. In fact, the radiation is initially produced by a laser source, which in itself does not place a limitation on the power of the radiation emitted towards the outside. However, implementation of the LIDAR system by using optical fiber connection technology offers considerable advantages, in particular an increased robustness of the system and the elimination of mechanisms for aligning the optical components of the system relative to each other. But the known phenomenon of stimulated Brillouin scattering, or SBS, which occurs in optical fibers limits the peak power value that each emitted pulse can have.

In addition, the frequency PRF is limited by the range of the LIDAR system. Indeed, it is necessary that a pulse of radiation emitted towards the target be detected in return before the next pulse is emitted, in order to correlate each detected radiation portion with the correct moment of pulse emission, so as to deduce from this the value for the distance away from the target. In other words, the frequency PRF is limited by the range L stipulated for the LIDAR system according to the formula: PRF<C/(2·L), where C is the speed of light.

Thus, these limitations on the energy of the emitted pulses and on the repetition frequency of the pulses, because of the resulting consequences for the signal-to-noise ratio of the heterodyne detection signals, prevent improving the precision of the measurement results, in particular airspeed measurement results.

### Technical Problem

Based on this situation, one object of the present invention is to propose a new pulsed LIDAR system in which the signal-to-noise ratio of the detection signals is improved.

A complementary object of the invention is for such a LIDAR system to be compatible with the use of optical fibers to interconnect the optical components inside the LIDAR system.

Another complementary object of the invention is for such a LIDAR system to be adapted for airspeed measurements.

### SUMMARY OF THE INVENTION

To achieve at least one of these or other objects, one aspect of the invention proposes a pulsed LIDAR system which is adapted to determine a value of a Doppler effect frequency shift undergone by a series of radiation pulses successively emitted by the system towards a target, between portions of the pulses as received after retroreflection or backscattering on the target and the same pulses as emitted by the system. The system then provides, based on the value determined for the frequency shift, an estimate of a speed component of the target which is parallel to an optical emission direction of the system. For this purpose, the system comprises:
a transmission path, configured to produce the series of pulses,
a detection path, configured to detect the pulse portions received after retroreflection or backscattering on the target, and to produce heterodyne detection signals which correspond to the pulses of the series, and
a spectral analysis module, adapted to carry out a spectral analysis of the heterodyne detection signals, so that the value of the frequency shift results from heterodyne detection contributions which correspond to the pulses of the series.
   The use of multiple pulses to perform the spectral analysis provides an initial improvement in the signal-to-noise ratio, and the accuracy of the measurement results provided by the LIDAR system is improved accordingly.

According to the invention, the LIDAR system has the following additional features:
the transmission path is further configured to form each of the pulses as a superposition of a plurality of pulse spectral components which are emitted simultaneously, are spectrally disjoint, and are associated one-to-one with different central wavelength values, and
the system is adapted so that the value of the frequency shift which is determined by the spectral analysis module results from a plurality of heterodyne detection contributions which respectively correspond to the pulse spectral components of the pulses of the series.

In the context of the invention, the term pulse spectral components which are spectrally disjoint is understood to mean components of the spectrum of each pulse between which a pulse spectral intensity becomes less than 5%, preferably less than 1%, of a maximum spectral intensity value of each pulse spectral component.

Thus, each pulse can have a peak power value which is greater than an agreed stimulated Brillouin scattering threshold, while each pulse spectral component separately has an individual peak power value which is less than the stimulated Brillouin scattering threshold. In other words, the limitation on the peak emission power which is caused by an optical fiber-based implementation of the transmission path is satisfied, while allowing each pulse to have an energy value which is increased. For this reason, the invention is particularly suitable when the LIDAR system uses optical fiber technology for its transmission path.

In addition, all the heterodyne detection contributions which respectively correspond to the pulse spectral components of the pulses, contribute to obtaining the value of the frequency shift, which is attributed to the Doppler effect produced by the movement of the target. Thus, the system of the invention has an operation in which the frequency PRF which is in effect is multiplied by the number of disjoint spectral components in each pulse, while maintaining a range L of the LIDAR system which is unchanged. The invention thus provides an additional improvement in the signal-to-noise ratio related to the heterodyne detection signal. The precision in the value obtained for the Doppler effect frequency shift is increased accordingly. According to another point of view, for a constant value of the range L, and while maintaining identical precision in the measurement results, the LIDAR system of the invention can allow reducing the accumulation time for the heterodyne detection signal by a factor which is equal to the number of pulse spectral components which are spectrally disjoint and constitute each emitted pulse.

Generally for the invention, it is not necessary that the pulses successively emitted by the LIDAR system, each with a plurality of spectral components which are spectrally disjoint, are identical. Thus, two pulses can differ from each other by the average wavelength values of at least some of their spectral components, in particular differing by the difference which exists between the spectral components from one pulse to one other. Thus, the composition of the pulses having a plurality of spectral components can vary during the series of pulses emitted for performing a measurement sequence, either periodically or randomly during this series. By means of such a differentiation between the pulses successively emitted, it is possible to increase the range of the LIDAR system while maintaining a constant value for the pulse repetition frequency, or PRF. Indeed, it is necessary that a pulse of radiation emitted towards the target be detected in return before emitting the next pulse, if the two pulses are identical, in order to correlate each detected radiation portion with the correct time the pulse was emitted, so as to deduce the value of the distance away from the target. In other words, when the successive pulses are identical, the frequency PRF is limited by the range L which is stipulated for the LIDAR system according to the formula: PRF<C/(2·L), where C is the speed of light. Using successive pulses which are different therefore makes it possible to increase the range L of the LIDAR system at an equal value for the frequency PRF, or to increase the value for the frequency PRF at a constant range L of the LIDAR system. The individual duration of each measurement sequence can thus be reduced. When several different spectral compositions are used for the pulses, while being repeated periodically, the individual duration of each measurement sequence can thus be divided by the number of different spectral compositions, at a constant range L of the LIDAR system.

The transmission path of the LIDAR system of the invention may comprise:
a laser emission source, adapted to produce an initial laser radiation, this initial laser radiation preferably being monochromatic or quasi-monochromatic;
a comb generation modulator, arranged to modify the initial laser radiation in accordance with a modulation signal applied to a control input of this comb generation modulator; and
a modulation signal generator, connected so as to apply the modulation signal to the control input of the comb generation modulator.
   The modulation signal is then such that the initial laser radiation is transformed by the comb generation modulator into a set of spectral components which are intended to form, one-to-one, the pulse spectral components. Put another way, the optical radiation exiting the modulator has a comb spectral structure.

In first embodiments of the invention, a reference input of the detection path may be connected to a secondary output of the transmission path in order to receive an optical reference signal which comprises reference spectral components corresponding, one-to-one, to the pulse spectral components of the pulses, with a spectral shift between each pulse spectral component and the corresponding one among the reference spectral components, which is identical for all the pulse spectral components. In this manner, the heterodyne detection contributions associated with the pulse spectral components in the heterodyne detection signal as produced by the detection path are all spectrally superimposed. In other words, the heterodyne detection signal is spectrally formed by a single peak which combines all the contributions produced by the plurality of pulse spectral components. For such first embodiments, the secondary output of the transmission path, which is connected to the reference input of the detection path, can be located in the transmission path downstream of the comb generation modulator, relative to a direction of propagation of the radiation in the transmission path.

In second embodiments of the invention, the reference input of the detection path may be connected to a secondary output of the transmission path which is differently located, in order to receive an optical reference signal which is monochromatic or quasi-monochromatic. Then, the heterodyne detection contributions associated with the pulse spectral components in the heterodyne detection signal as produced by the detection path, are spectrally shifted relative to each other in accordance with a distribution of the pulse spectral components. In this case, the spectral analysis module is adapted to deduce the value of the Doppler effect frequency shift based on central frequency values which are respectively relative to each of the heterodyne detection contributions. For such second embodiments, the secondary output of the transmission path, which is connected to the reference input of the detection path, can be located in the transmission path upstream of the comb generation modulator, relative to a direction of propagation of the radiation in this transmission path.

In preferred embodiments of the invention, at least one of the following additional characteristics may optionally be reproduced, alone or in a combination:
the LIDAR system may be adapted to provide an estimate of an air flow speed component when the system is pointed to emit the radiation pulses towards a portion of the atmosphere which contains suspended particles forming the target, the particles being backscatterers for the radiation;
the transmission path may further be configured so that the spectral components of each pulse are spectrally separated by at least 10 MHZ, preferably at least 20 MHZ, and at most 2000 MHz;
the transmission path may further be configured so that spectral differences which exist between any two of the pulse spectral components which are spectral neighbors are constant between different pairs of pulse spectral components which are neighbors;
the transmission path may further be configured so that the number of spectrally disjoint pulse spectral components which constitute each pulse is between 2 and 20, preferably between 4 and 12;
each pulse spectral component may be monochromatic or quasi-monochromatic;
the comb generation modulator, when such a modulator is used, may be an electro-optical modulator;
the modulation signal generator, when such a generator is used, may be an electrical generator of arbitrary waveforms; and
the transmission path and/or the detection path may be implemented by optical fiber technology, to interconnect components of this transmission path and/or detection path.

### BRIEF DESCRIPTION OF FIGURES

The features and advantages of this invention will become more clearly apparent from the detailed description below of some non-limiting exemplary embodiments, with reference to the appended figures in which:

FIG. 1a is a block diagram of a pulsed LIDAR device with heterodyne detection as known from the prior art;

FIG. 1b groups two spectral diagrams relating to the operation of the LIDAR system of [FIG. 1a];

FIG. 2 is a timing diagram which shows a possible spectral composition of pulses for an operation of a LIDAR system according to the invention;

FIG. 3a corresponds to [FIG. 1a] for a first embodiment of the invention;

FIG. 3b corresponds to [FIG. 1b] for the LIDAR system of the first embodiment of the invention of [FIG. 3a];

FIG. 4a corresponds to [FIG. 1a] for a second embodiment of the invention;

FIG. 4b corresponds to [FIG. 1b] for the LIDAR system of the second embodiment of the invention of [FIG. 4a]; and

FIG. 5 corresponds to [FIG. 2] for another embodiment of the invention.

### DETAILED DESCRIPTION OF THE INVENTION

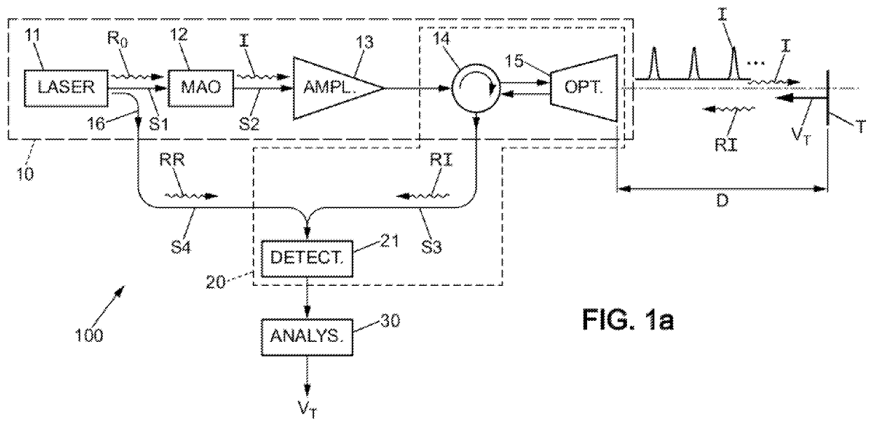

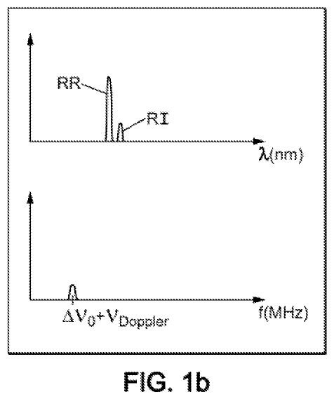

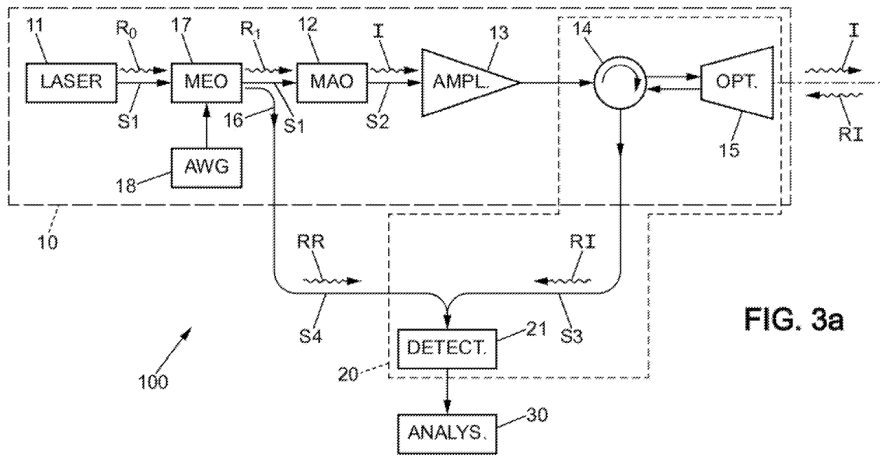

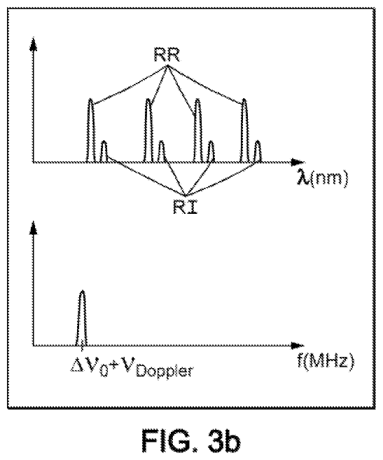

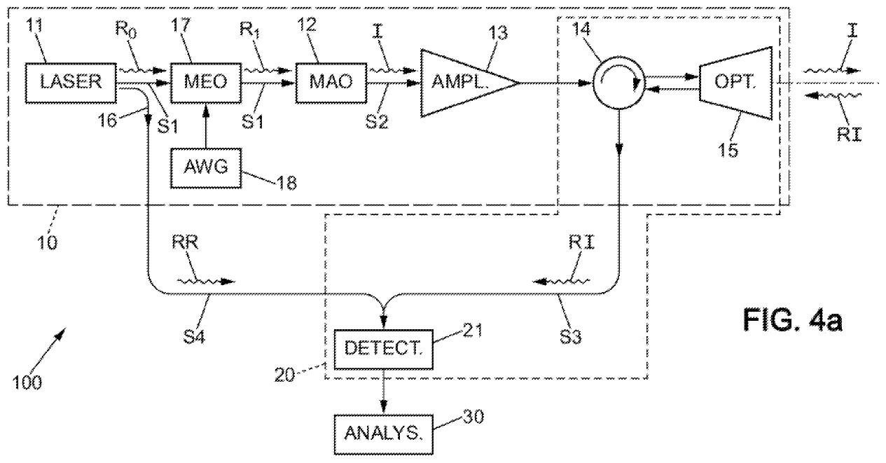

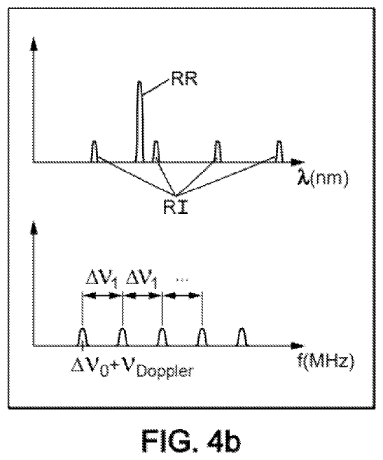

In these figures, all the components are represented symbolically, and identical references indicated in different figures designate elements which are identical or have identical functions. For clarity sake, components whose use in a LIDAR system is known to those skilled in the art, and which are not directly concerned by the invention, are not described below. In such case, their possible adaptation to the invention is within the reach of such persons skilled in the art. In [FIG. 1a], [FIG. 3a], and [FIG. 4a], the following references used have the meanings indicated here:
100 general designation for a pulsed LIDAR with heterodyne detection
10 transmission path
11 laser emission source, denoted LASER
12 frequency shift and pulse cutting modulator, denoted MAO
13 optical amplifier, denoted AMPL.
14 optical circulator
15 emission optics, denoted OPT.
16 secondary output of the transmission path
20 detection path
21 heterodyne detector, denoted DETECT.
30 spectral analysis module, denoted ANALYS.

FIG. 1a shows a system 100 as known prior to the present invention.

Transmission path 10 comprises laser emission source 11, modulator 12, optical amplifier 13, optical circulator 14, and emission optics 15. Laser emission source 11 may be a continuous emission source, with an emission wavelength of approximately 1550 nm (nanometers) and a power of 600 μJ (microjoules), for example. It thus produces an initial laser radiation R₀ which is monochromatic or quasi-monochromatic. Initial laser radiation R₀ is transmitted to modulator 12. Modulator 12 may be an acousto-optic type of modulator. It is controlled to form, from the radiation it has received, identical pulses I of individual durations which can be between 200 ns (nanoseconds) and 800 ns, with a pulse repetition frequency PRF which can be 10 kHz (kilohertz) for example. Simultaneously, modulator 12 can be controlled to shift the optical frequency of the radiation by applying a frequency shift Δv₀ to it, which can be equal to 100 MHz (megahertz) for example. Pulses I thus produced by modulator 12 are amplified by optical amplifier 13, then transmitted to emission optics 15 via optical circulator 14. Emission optics 15 can have a telescope structure, for example. The amplified pulses I are thus transmitted towards a target T, which is external to LIDAR system 100 and located at a distance D from it, measured along the direction of emission of system 100. In principle, separation distance D is less than range L of system 100, the range possibly being equal to approximately 15 km (kilometers) as an example.

All pulses I thus emitted by system 100 of [FIG. 1a] are identical and monochromatic or quasi-monochromatic.

Secondary output 16 is located in transmission path 10, between laser emission source 11 and the modulator 12 dedicated to shifting and separation of the pulses I.

Detection path 20 shares emission optics 15 and optical circulator 14 with transmission path 10, and further comprises heterodyne detector 21. Within detection path 20, one function of optics 15 is to collect portions RI of pulses I which have been retroreflected or backscattered by target T. Heterodyne detector 21 is optically coupled so as to receive the portions RI of retroreflected or backscattered pulses which have been collected by optics 15, via optical circulator 14, and to receive simultaneously an optical reference signal RR which is collected from transmission path 10 via secondary output 16 of this transmission path. In other words, secondary output 16 is optically coupled to heterodyne detector 21 in addition to the output of optical circulator 14 which is dedicated to detection path 20. Heterodyne detector 21 may be a photodiode, in particular an ultrafast photodiode, onto which are focused the optical reference signal RR which comes from secondary output 16 and the pulse portions RI which come from target T.

Spectral analysis module 30 is configured for spectrally analyzing the heterodyne detection signals produced by detector 21 during the operation of system 100. It is configured to deduce, from this spectral analysis, a value of a frequency shift which exists between optical reference signal RR and pulse portions RI. It is further configured to convert the value of the frequency shift thus obtained into a speed component value V_{T} for target T, parallel to the direction of emission of system 100. In a known manner: V_{T}=−λ₀·(vₘ−Δv₀)/2, where:
λ₀ designates the wavelength of laser emission source 11, equal to approximately 1550 nm in the example given above,
Δv₀ further designates the frequency shift applied by modulator 12, equal to 100 MHz in the example given above, and
vₘ is a frequency within the radio frequency domain, or RF domain, which is associated with a maximum intensity or a central peak position in the spectral decomposition of the heterodyne detection signal.

System 100 is preferably implemented using optical fiber technology. In such case, optical amplifier 13 can be of the type designated by EDFA, for “Erbium-Doped Fiber Amplifier”. Initial laser radiation R₀ is transmitted by a first optical fiber segment S1 from laser emission source 11 to modulator 12, then from the latter to amplifier 13 via a second optical fiber segment S2. In addition, retroreflected or backscattered pulse portions RI which are collected by optics 15 are injected into a third optical fiber segment S3 at the output of optical circulator 14 in order to convey them to heterodyne detector 21. In parallel, secondary output 16 of transmission path 10 is implemented by a fiber-optic coupler, and connected to heterodyne detector 21 by a fourth optical fiber segment S4.

For an operation of the just-described system 100 with a retroreflecting point target, the heterodyne detection signal has a sinusoidal variation at frequency vₘ. The upper diagram of [FIG. 1b] shows the spectral composition of the radiation received by heterodyne detector 21. The horizontal axis of this upper diagram of [FIG. 1b] identifies the wavelength values in the optical domain, denoted λ and expressed in nanometers (nm). The vertical axis, in arbitrary units, identifies the spectral intensity values. The radiation received by heterodyne detector 21 comprises a first contribution which is composed of optical reference signal RR conveyed from secondary output 16, and a second contribution which corresponds to pulse portions RI which have been retroreflected by target T. For system 100 of [FIG. 1a], optical reference signal RR is a portion of initial laser radiation R₀, such that the corresponding contribution in the upper diagram of [FIG. 1b] is a very narrow peak, denoted RR. When target T is located at a single location along the emission direction of system 100, the second contribution also has the shape of a narrow peak, denoted RI. The lower diagram of [FIG. 1b] shows the spectral composition of the heterodyne detection signal which corresponds to the spectral composition of the radiation received by detector 21 as shown in the upper diagram. The heterodyne detection signal then consists of a single peak, for which the frequency is vₘ=Δv₀+v_{Doppler}, where v_{Doppler}≈−2·V_{T}/λ₁, λ₁ being the wavelength value of the radiation as emitted by LIDAR system 100. The horizontal axis of the lower diagram of [FIG. 1b] identifies the frequency values in the RF domain, which are denoted f and expressed in megahertz (MHz). The vertical axis is again in arbitrary units for identifying the spectral intensity values of the heterodyne detection signal.

For an operation of system 100 which is dedicated to airspeed measurements, pulses I are backscattered by a multiplicity of targets distributed along the path of the pulse beam external to system 100, starting from emission optics 15. These targets, which are composed of particles or aerosols suspended in the air, are pulled along as a function of the local speed of air movement existing at each location in the path of the beam. Those skilled in the art commonly refer to such a distribution of targets as “extended target”, “distributed target”, or “volume target”. Pulse portions RI which are collected by optics 15 then transmitted to detector 21 are thus spread over time, corresponding to different separation distances along the direction of emission of system 100, where partial backscattering of pulses I occurs. Furthermore, they are frequency shifted in a manner that varies depending on the local wind speed parallel to the direction of emission at the location where each partial backscattering occurs. The heterodyne detection signal then has more complex temporal variations. The spectral analysis carried out by module 30 is assumed to be known: for the result, it provides a series of speed values V_{T} which are assigned one-to-one to different values of the separation distance D. In a known manner, the resolution in separation distance D is determined by the individual duration of the emitted pulses I, being equal to this individual duration divided by twice the pulse propagation speed outside LIDAR system 100. In comparison to the diagrams of [FIG. 1b], the peak which corresponds to pulse portions RI in the spectral composition of the radiation received by detector 21 is broadened. The peak of the spectral composition of the heterodyne detection signal, in the RF domain, is broadened in a correlated manner.

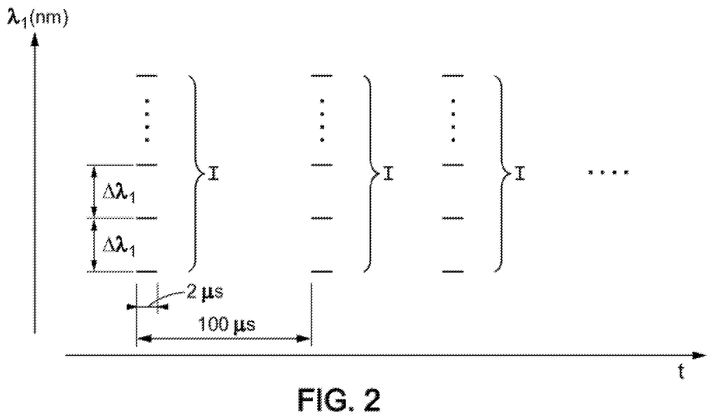

The horizontal axis of the diagram in [FIG. 2] identifies the time, denoted t, and its vertical axis identifies the instantaneous emission wavelength λ₁ of a LIDAR system 100 which is in accordance with the invention. Wavelength λ₁ is expressed in nanometers (nm). In accordance with this diagram, each pulse I as emitted by LIDAR system 100 consists of a plurality of pulse spectral components which are simultaneous, and therefore are superimposed to form the pulse. Each pulse spectral component is monochromatic or quasi-monochromatic, and each pulse I can be composed of ten such pulse spectral components, as an example. The differences between the wavelength values of two spectrally neighboring pulse spectral components can be constant, but this is not necessarily so. They can be any value, but sufficient for the frequency shift possessed by the retroreflected or backscattered pulse portions RI to be contained within all the separation intervals between different pulses. For this purpose, these differences are preferably greater than 30 MHz or 50 MHz, this lower limit being sufficient to obtain a reduction in the stimulated Brillouin scattering. When they are constant, the wavelength differences between neighboring spectral components are called wavelength increments, and denoted Δλ₁. Wavelength increment Δλ₁ corresponds to a frequency increment Δv₁ which is equal to −C·Δλ₁/λ₀². This latter increment can be equal to 200 MHZ, for example, in the RF domain. Thus, each pulse I is spectrally composed of a comb, and all pulses I successively emitted by LIDAR system 100 are identical, with this same individual composition. Such successfully emitted pulses I may have individual durations equal to 2 μs (microseconds), and be emitted every 100 μs.

In the example just described, the pulse repetition frequency of pulses I is equal to 10 kHz, while the pulse frequency which is in effect for measuring target speeds, i.e. frequency PRF, is equal to the product of this pulse repetition frequency and the number of pulse spectral components in each of pulses I, i.e. 100 kHz.

Such an operation in accordance with the invention can be produced by a LIDAR system 100 as represented in [FIG. 3a]. This system has a hardware architecture that is similar to that of [FIG. 1a], except that transmission path 10 further comprises an additional modulator 17 and a modulation signal generator 18. Modulator 17 can be of the electro-optical modulator type, and is denoted MEO. It is inserted in first optical fiber segment S1, between laser emission source 11 and electro-acoustic modulator 12. Modulation signal generator 18 can be of the arbitrary waveform generator type, denoted AWG. Generator 18 is programmed to transmit to a control input of modulator 17 an electrical modulation signal which can be composed of a sum of n sinusoidal components, where n is an integer. n can be between 1 and 9 inclusive, and preferably less than or equal to 5. In a known manner, an electro-optical modulator modulates the phase of the optical radiation supplied to it as input. The amplitude of each sinusoidal component of the electrical modulation signal is proportional to a dimensionless adjustment parameter which is commonly called the modulation depth. Initial laser radiation R₀ which comes from laser source 11 is thus transformed by modulator 17 into radiation R₁ which comprises a superposition of a plurality of spectral components in the form of disjoint lines. Each sinusoidal component of the electrical modulation signal produces a plurality of spectral components of radiation R₁ which are spectrally symmetrical with respect to wavelength value λ₀ of initial laser radiation R₀. The positions of all the spectral components thus produced depend on the number of sinusoidal components in the electrical modulation signal, and on the values adopted for their respective modulation depths. Radiation R₁ may or may not still comprise a spectral component at wavelength value λ₀. Although [FIG. 2] shows that the spectral components are spectrally equidistant within each pulse I, this is not necessarily the case. As examples, the following compositions are possible for the electrical modulation signal:
a single sinusoidal modulation component, associated with the value of 1.44 for its modulation depth, resulting in a radiation R₁ which is mainly composed of three spectrally disjoint lines located at the following wavelengths: λ₀, λ₀−Δλ₁, and λ₀+Δλ₁, where Δλ₁ is the wavelength difference between successive lines in radiation R₁, these three lines having respective intensities which are substantially identical;
a single sinusoidal modulation component, associated with the value of 2.6 for its modulation depth, resulting in a radiation R₁ which is mainly composed of four spectrally disjoint lines located at the following wavelengths: λ₀−2·Δλ₁, λ₀−Δλ₁, λ₀+Δλ₁, and λ₀+2·Δλ₁, these four lines having respective intensities which again are substantially identical; and
two sinusoidal modulation components, for example with respective frequencies which are equal to 100 MHz and 30 MHZ, and both associated with the value of 1.44 for their respective modulation depths, resulting in a radiation R₁ which is mainly composed of nine spectrally disjoint lines whose respective intensities are substantially identical.

Modulator 12 then applies frequency shift Δv₀ to each of the spectral components of radiation R₁. It further applies the subdivision into temporally-separated pulses to all spectral components, so that each pulse I emitted by transmission path 10 towards the outside is composed of a plurality of spectral components which are all superimposed for the duration of the pulse. In the jargon of those skilled in the art, radiation R₁ which is output by modulator 17, as well as each pulse I emitted by system 100, is now composed of a comb of spectral components. Preferably, frequency increment Δv₁ is greater than the sum of the spectral width of the components of the electrical modulation signal plus laser source 11, such that the comb's spectral components are spectrally disjoint.

Alternatively to the use of an arbitrary waveform generator, the n sinusoidal components of the electrical modulation signal may be produced by a combination of n analog electrical oscillators. Such an alternative mode of generating the electrical modulation signal can in fact be simpler to implement.

When retroreflected, each pulse spectral component is spectrally shifted due to the Doppler effect. Given that frequency increment Δv₁ is much lower than the optical frequency which corresponds to wavelength λ₀, all the pulse spectral components undergo the same Doppler effect frequency shift v_{Doppler}. In addition, frequency increment Δv₁ is chosen to be greater than all values possibly expected for the Doppler effect frequency shift v_{Doppler} added to frequency shift Δv₀.

Secondary output 16 of transmission path 10 is located between modulators 17 and 12 for the embodiment of [FIG. 3a]. In this manner, optical reference signal RR which is conveyed to heterodyne detector 21 is part of radiation R₁. It is therefore also constructed by a comb having a frequency increment Δv₁.

As shown by the upper diagram of [FIG. 3b], the spectral composition of the radiation received by heterodyne detector 21 then comprises the comb of frequency increment Δv₁, designated RR, and an additional comb, which is designated RI and which corresponds to the pulse portions which were retroreflected or backscattered then collected by optics 15. This additional comb contains the measurement information. It is shifted relative to comb RR by Δv₀+v_{Doppler}, in terms of optical frequency, also having Δv₁ as the frequency increment. During heterodyne detection, each spectral component of comb RR forms interference with each of the spectral components of comb RI, but appropriate filtering eliminates all interference between a component of comb RR and a component of comb RI which are not spectrally neighboring, meaning which are distant from each other by more than 0.3·Δv₁, for example. It is possible for such filtering to be performed by detector 21 itself, due to its characteristic response time. All that remains, in the heterodyne detection signal, are contributions which correspond to the interference between each component of comb RR and of comb RI which is shifted relative thereto by Δv₀+v_{Doppler}. These contributions are then spectrally superimposed onto each other in the heterodyne detection signal, as can be seen in the lower diagram of [FIG. 3b]. Although these pulse spectral components are incoherent with each other in pulse portions RI which reach detector 21, the heterodyne detection signal has an increased signal-to-noise ratio value calculated on the spectrum compared to system 100 of [FIG. 1a]. For this embodiment of [FIG. 3a], spectral analysis module 30 can be identical to the one in system 100 of [FIG. 1a].

The embodiment of [FIG. 4a] is distinguished from that of [FIG. 3a] by the location of secondary output 16 in transmission path 10. It is now located between laser emission source 11 and comb generation modulator 17. Modulator 17 and modulation signal generator 18 can be identical to those of the embodiment of [FIG. 3a], and the electrical modulation signal is unchanged. Pulses I which are emitted by system 100 towards the outside therefore have the same spectral composition. On the other hand, optical reference signal RR which is conveyed from new secondary output 16 is identical to the one occurring in system 100 of [FIG. 1a]. As shown in the upper diagram of [FIG. 4b], the spectrum of the radiation received by heterodyne detector 21 comprises peak RR which corresponds to the emission from laser emission source 11, and the comb which is formed by the retroreflected or backscattered pulse portions RI which were collected. This second comb is again designated RI. Each spectral component of comb RI again corresponds to the pulse spectral components affected by frequency shift v_{Doppler}. These spectral components are again incoherent in the retroreflected or backscattered pulse portions RI that have been collected. When heterodyne detector 21 has a sufficiently short response time, the heterodyne detection signal is composed of interferences of the spectral component of peak RR with each of the spectral components of comb RI. The heterodyne detection signal is then composed of a plurality of spectral components, whose RF central frequency values are Δv₀+v_{Doppler}+i·Δv₁, where i is an integer index which identifies the spectral components of the heterodyne detection signal. This spectral composition of the heterodyne detection signal is shown by the lower diagram of [FIG. 4b]. Spectral analysis module 30 determines the value of the Doppler effect frequency shift v_{Doppler} based on the RF frequency values measured for the central values Δv₀+v_{Doppler}+i·Δv₁. For example, an elementary value is determined for v_{Doppler} based on each of the central values Δv₀+v_{Doppler}+i·Δv₁, and the final value of v_{Doppler} is calculated by averaging the elementary values. It is possible for RF frequency values which correspond to the maximum intensity values of the RI peaks in the spectrum of the heterodyne detection signal to be used instead of the central frequency values of the same peaks, in order to determine the elementary values of v_{Doppler} which are deduced from the individual positions of the RI peaks.

Although the implementation of distance resolution has not been described in connection with the embodiments of [FIG. 3a] and [FIG. 4a] to obtain speed measurement results which relate to sampled separation distance values, the principle of obtaining such a distance resolution can be used as was described for system 100 of [FIG. 1a].

For the embodiments of [FIG. 3a] and [FIG. 4a], each pulse spectral component can have an individual peak power value which is just below a threshold for the stimulated Brillouin scattering which occurs in optical fiber segments S1 and S2 as well as in optical amplifier 13, optical circulator 14, and the optical fiber segments between these and leading to emission optics 15. The power of each pulse I emitted by system 100 towards the outside in order to perform a speed measurement is multiplied by the number n_{comp} of spectral components utilized in each pulse, compared to the system of [FIG. 1a]. An improvement by a factor n_{comp}^{1/2} is thus obtained for the operation of the LIDAR system with heterodyne detection. Pulsed LIDAR systems with heterodyne detection in accordance with the invention are therefore particularly suitable for measurement conditions where the retroreflected or backscattered pulse portions have low or very low power. They are therefore particularly suitable for carrying out airspeed measurements.

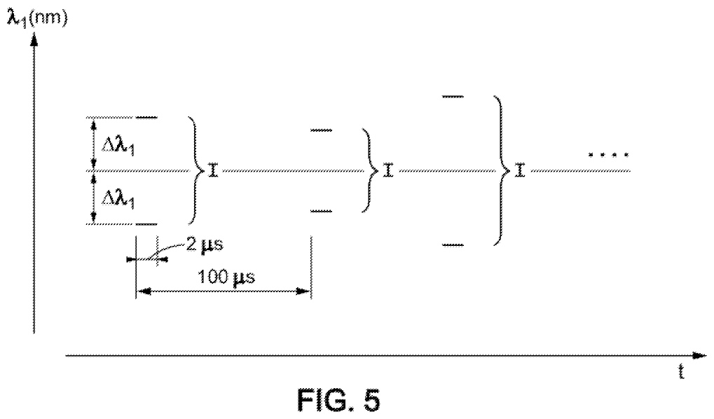

In the embodiments of the invention which have been described above, the respective spectral compositions of the pulses successively emitted by the LIDAR system are identical. But this characteristic is not necessary for the invention. [FIG. 5] shows a series of pulses I which are successively emitted by the LIDAR system, for which each pulse I is composed of two disjoint spectral components separated by wavelength difference 2·Δλ₁. This inter-component spectral difference 2·Δλ₁ varies between two successive pulses I, for example periodically during the complete series of pulses I. The use of such a series of pulses of variable spectral compositions is compatible with the two embodiments of LIDAR systems according to the invention of [FIG. 3a] and [FIG. 4a]. The series of emitted pulses which is illustrated by [FIG. 5] is obtained in both cases by appropriately controlling electro-optical modulator 17. Although [FIG. 5] only shows two spectral components per pulse, the number of spectral components per pulse may be greater. In particular, but optionally, the control of electro-optical modulator 17 can be configured so that radiation R₁ as coming directly from modulator 17 before being transmitted to acousto-optic modulator 12, is devoid of any significant spectral amplitude component at wavelength value λ₀ of laser emission source 11.

It is understood that the invention can be reproduced while modifying secondary aspects of the embodiments described in detail above, while retaining at least some of the cited advantages. In particular, the following modifications are possible:
some of the components used in the described embodiments can be replaced by other components or by combinations of components which produce equivalent functions. For example, each electro-optical modulator can be replaced by a semiconductor optical amplifier, or SOA, used as a modulator;
in general for the invention, it is not necessary that the spectrally disjoint pulse spectral components for constituting each pulse emitted by the LIDAR system, have respective component intensities which are equal. In other words, the spectrally disjoint pulse spectral components for constituting each pulse can have maximum spectral intensities or respective total intensities which differ from one component to another within the same emitted pulse; and
all numerical values which have been cited are for illustrative purposes only, and can be changed according to the application considered for the pulsed LIDAR system with heterodyne detection.

1-11. (canceled)

12. A pulsed LIDAR system, adapted to determine a value of a Doppler effect frequency shift which is undergone by a series of radiation pulses successively emitted by the system towards a target, between portions of the pulses as received after retroreflection or backscattering on the target and said pulses as emitted by the system, and to provide, based on the value determined for the frequency shift, an estimate of a speed component of the target which is parallel to an optical emission direction of the system,
the system comprising:
a transmission path, configured to produce the series of pulses,
a detection path, configured to detect the pulse portions received after retroreflection or backscattering on the target, and to produce heterodyne detection signals which correspond to the pulses of the series,
a spectral analysis module, adapted to carry out a spectral analysis of the heterodyne detection signals, so that the value of the frequency shift results from heterodyne detection contributions which correspond to the pulses of the series, and
the transmission path being further configured to form each of the pulses as a superposition of a plurality of pulse spectral components which are emitted simultaneously, are spectrally disjoint, and are associated one-to-one with different central wavelength values, and
the system being adapted so that the value of the frequency shift which is determined by the spectral analysis module results from a plurality of heterodyne detection contributions which respectively correspond to the pulse spectral components of the pulses of the series,
wherein the system is further adapted so that the disjoint pulse spectral components of two pulses which are successively emitted are separated by a spectral inter-component difference which varies between said two successive pulses, and so that said spectral inter-component difference periodically varies during the complete series of pulses.

13. The pulsed LIDAR system according to claim 12, adapted to provide an estimate of an air flow speed component when the system is pointed to emit the radiation pulses towards a portion of the atmosphere which contains suspended particles forming the target, the particles being backscatterers for said radiation.

14. The pulsed LIDAR system according to claim 12, wherein the transmission path is further configured so that the spectral components of each pulse (I) are spectrally separated by at least 10 MHz, preferably at least 20 MHz, and at most 2000 MHz.

15. The pulsed LIDAR system according to claim 12, wherein the transmission path is further configured so that spectral differences which exist between any two of the pulse spectral components which are spectral neighbors are constant between different pairs of pulse spectral components which are neighbors.

16. The pulsed LIDAR system according to claim 12, wherein the transmission path is further configured so that the number of the spectrally disjoint pulse spectral components which constitute each pulse is between 2 and 20, preferably between 4 and 12.

17. The pulsed LIDAR system according to claim 12, wherein the transmission path comprises:
a laser emission source, adapted to produce an initial laser radiation;
a comb generation modulator, arranged to modify the initial laser radiation in accordance with a modulation signal applied to a control input of said comb generation modulator; and
a modulation signal generator, connected so as to apply the modulation signal to the control input of the comb generation modulator,
said modulation signal being such that the initial laser radiation is transformed by the comb generation modulator into a set of spectral components which are intended to form, one-to-one, the pulse spectral components.

18. The pulsed LIDAR system according to claim 17, wherein the comb generation modulator is of electro-optical type, and the series of the pulses with the spectral inter-component difference which varies between two successively emitted pulses is obtained by a control of the electro-optical comb generation modulator.

19. The pulsed LIDAR system according to claim 18, wherein the control of the electro-optical comb generation modulator is designed so that the radiation as produced directly by said modulator, before being transmitted to a modulator dedicated to frequency-shifting and separation into pulses of acousto-optical type, is devoid of spectral component at an emission wavelength value of the laser emission source.

20. The pulsed LIDAR system according to claim 12, wherein a reference input of the detection path is connected to a secondary output of the transmission path in order to receive an optical reference signal which comprises reference spectral components corresponding, one-to-one, to the pulse spectral components of the pulses, with a spectral shift between each pulse spectral component and the reference spectral component which corresponds to said pulse spectral component, which is identical for all pulse spectral components,
so that the heterodyne detection contributions associated with the pulse spectral components in the heterodyne detection signal as produced by the detection path are all spectrally superimposed.

21. The pulsed LIDAR system according to claim 17, wherein a reference input of the detection path is connected to a secondary output of the transmission path in order to receive an optical reference signal which comprises reference spectral components corresponding, one-to-one, to the pulse spectral components of the pulses, with a spectral shift between each pulse spectral component and the reference spectral component which corresponds to said pulse spectral component, which is identical for all pulse spectral components, so that the heterodyne detection contributions associated with the pulse spectral components in the heterodyne detection signal as produced by the detection path are all spectrally superimposed and wherein the secondary output of the transmission path is located in said transmission path downstream of the comb generation modulator, relative to a direction of propagation of the radiation in said transmission path.

22. The pulsed LIDAR system according to claim 12, wherein a reference input of the detection path is connected to a secondary output of the transmission path in order to receive an optical reference signal which is monochromatic,
so that the heterodyne detection contributions associated with the pulse spectral components in the heterodyne detection signal as produced by the detection path, are spectrally shifted relative to each other in accordance with a distribution of the pulse spectral components,
and wherein the spectral analysis module is adapted to deduce the value of the Doppler effect frequency shift based on central frequency values which are respectively relative to each of the heterodyne detection contributions.

23. The pulsed LIDAR system according to claim 17, wherein a reference input of the detection path is connected to a secondary output of the transmission path in order to receive an optical reference signal which is monochromatic, so that the heterodyne detection contributions associated with the pulse spectral components in the heterodyne detection signal as produced by the detection path, are spectrally shifted relative to each other in accordance with a distribution of the pulse spectral components, and wherein the spectral analysis module is adapted to deduce the value of the Doppler effect frequency shift based on central frequency values which are respectively relative to each of the heterodyne detection contributions and wherein the secondary output of the transmission path is located in said transmission path upstream of the comb generation modulator, relative to a direction of propagation of the radiation in said transmission path.

24. The LIDAR system according to claim 12, wherein at least one of the transmission path and detection path is implemented by an optical fiber technology, to interconnect components of said transmission path or detection path respectively.
